(19) United States
(12) Patent Application Publication
(10) Pub. No.: US 2008/0023315 A1
(43) Pub. Date: Jan. 31, 2008

(54) Switch device

(75) Inventor: Tatsuhide Morisawa, Tottori-ken (JP)

Correspondence Address: OSHA LIANG L.L.P., 1221 MCKINNEY STREET, SUITE 2800, HOUSTON, TX, 77010, US

(73) Assignee: OMRON Corporation, Kyoto-shi (JP)

(21) Appl. No.: 11/881,156

(22) Filed: Jul. 25, 2007

(30) Foreign Application Priority Data
Jul. 25, 2006 (JP) 2006-201976

(51) Int. Cl. H01H 13/14

(52) U.S. Cl. 200/520

(57) ABSTRACT

The pushing operability is freely adjustable. A switch device includes a switch including a push-in operable operation part; a housing attached to the switch; a push-in unit, turnably attached to the housing, for pushing in the operation part; a biasing unit, arranged in the housing, for biasing the push-in unit to position the operation part at a non-push-in position before being pushed in; and a biasing force adjusting unit for adjusting the biasing force applied on the push-in unit by the biasing unit at multi-levels or no level.

### BACKGROUND OF THE INVENTION

1. Field of the Invention

The present invention relates to a switch device, in particular, to a switch device having a function of adjusting operating force when opening and closing the switch.

2. Description of the Related Art

Conventionally, a switch device in which a transmission member is turned about a turning axis by pushing in an operation member arranged at an opening of a case main body, and the operation load is adjusted by the positional relationship of the transmission force point and the transmission acting point of the transmission member and the pushing member is known (see, for example, Japanese Patent Application Laid-Open No. 9-293426).

However, in the conventional switch device, the operation load can be adjusted by changing a component of the switch at the assembly stage, but the operation load cannot be adjusted after actually incorporated in a device. When miniaturization of the switch such as a mouse etc. to be connected to a computer is desired, the space for obtaining an adjusting amount of the operation load is insufficient with the adjustment method by the positional relationship of the transmission force point and the transmission acting point, and thus only a slight adjustment width can be ensured. Fingers may become tired within a short period of time when the push-in operation force is too strong in the operation switch for use as a mouse for games etc. with which push-in operation is frequently performed as compared with the conventional personal computer operation. When the push-in operation force is too weak, clicking is sometimes performed by mistake at unnecessary locations. Thus, enhancement of detailed operability that meets the need of the user and adjustment of load at the time of device assembly and at the time of operation are desired.

### SUMMARY OF THE INVENTION

The present invention aims to provide a switch device in which a load can be freely adjusted at the time of device assembly and at the time of operation.

In order to overcome the above problem, the present invention proposes a switch device including: a switch including a push-in operable operation part; a housing attached to the switch; a push-in unit turnably attached to the housing to push in the operation part; a biasing unit arranged in the housing, for biasing the push-in unit to position the operation part at a non-push-in position before being pushed in; and a biasing force adjusting unit for adjusting the biasing force applied on the push-in unit by the biasing unit at multi-levels or no level.

According to such configuration, the operation part of the switch is pushed in when the push-in unit is turned thereby turning ON the switch. The push-in operation of the push-in unit is performed against the biasing force of the biasing unit, and the biasing unit is adjusted at multi-levels or no level by the biasing force adjusting unit. Therefore, the force necessary to push in the push-in unit can be freely set according to the need of the user, thereby enhancing the operability.

The biasing force adjusting unit may have a configuration in which a distance to the push-in unit in which the biasing unit is arranged is adjustable.

The switch device may further include a holding unit arranged in a reciprocating manner in the housing, and the biasing unit is preferably held between the holding unit and the push-in unit; and the biasing force adjusting unit contacts the holding unit to adjust the position in the reciprocating direction.

Preferably, the biasing unit includes a coil spring; the holding unit includes a spring holder of a bottomed tubular shape in which one end side of the coil spring is arranged, the spring holder including a projection passing through the housing and projecting to the side opposite from the push-in unit; and the biasing force adjusting unit is rotatably attached to the housing on the side opposite from the push-in unit, is contacted by the projection passed through the housing and projected, and includes a contacting part for displacing the position in the reciprocating direction with respect to the projection by being rotated.

According to such configuration, that is, according to the configuration of the rotation-operated biasing force adjusting unit, the contacting position with respect to the projection of the spring holder by the contacting part can be displaced in the reciprocating direction of the spring holder. Therefore, compact configuration is achieved without requiring a wide occupying space.

The contacting part of the spring holder is preferably configured by a plurality of supporting boards continuous in a staircase pattern in the rotating direction.

According to such configuration, when the biasing force adjusting unit is rotation-operated, the contacting part of the spring holder sequentially moves to the adjacent supporting board. Therefore, click feeling is obtained according to the rotating operation of the biasing force adjusting unit.

Each supporting board preferably includes an engagement concave part with which the projection of the spring holder is detachably engaged.

According to such configuration, the projection moved to each supporting board is engaged with the engagement concave part, and a positional shift is prevented. Therefore, adjustment of the biasing force by the biasing force adjusting unit is performed in a stable state.

Preferably, the switch is mounted on a substrate; and the biasing force adjusting unit is slidably arranged on the substrate, and is configured by a slide member for displacing the reciprocating position of the holding unit by the slide position.

According to the present invention, the biasing force acting on the push-in unit is adjusted at multi-levels or no level, whereby the operability that meets the preference of the user is obtained, and furthermore, it can be easily assembled by simply attaching a housing etc. using an existing switch.

### BRIEF DESCRIPTION OF THE DRAWINGS

FIG. 1 shows a perspective view of a switch device according to an embodiment of the present invention;

FIG. 2 shows an exploded perspective view of the switch device shown in FIG. 1;

FIG. 3 shows a front view of the switch device shown in FIG. 1;

FIG. 4 shows a cross sectional view of FIG. 3;

FIG. 5 shows a perspective view of a housing shown in FIG. 2;

FIG. 6 shows a front view of the housing shown in FIG. 5;

FIG. 7 shows a perspective view of an adjustment dial shown in FIG. 2;

FIG. 8 shows a plan view of the adjustment dial shown in FIG. 7:

FIG. 9 shows a perspective view showing a state in which the switch device shown in FIG. 1 is attached to a printed substrate;

FIG. 10 shows a front view of FIG. 9:

FIG. 11 shows a perspective view showing a state in which a switch device according to another embodiment is attached to the printed substrate;

FIG. 12 shows a partially cut-out plan view of FIG. 11;

FIG. 13 shows a cross sectional view of FIG. 11; and

FIG. 14 shows a cross sectional view of a switch device according to another embodiment.

### DETAILED DESCRIPTION OF THE PREFERRED EMBODIMENTS

Embodiments of the present invention will now be described with reference to the accompanying drawings.

### First Embodiment

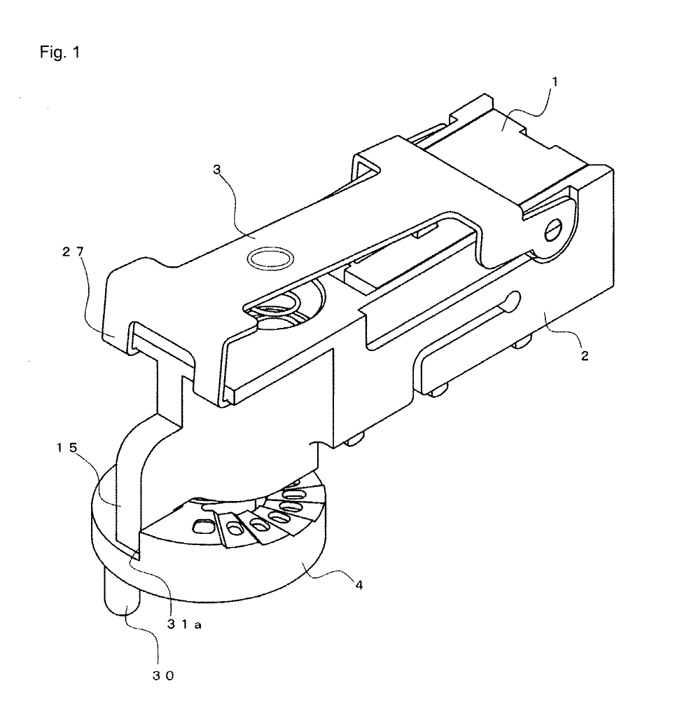

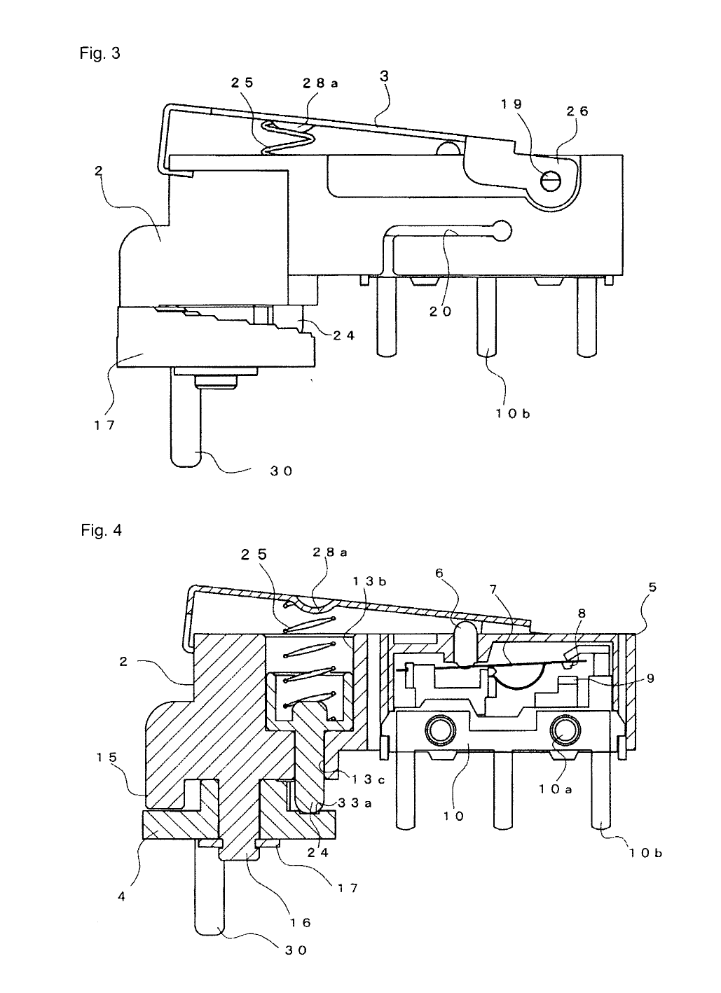

FIGS. 1 to 3 show a switch device SW according to the first embodiment. The switch device SW is generally configured by a switch 1, a housing 2, a drive lever 3, and an adjustment dial 4.

The conventionally well-known switch 1 (see e.g., Japanese Patent Application Laid-Open No. 4-249015) has a button 6 or an operation unit exposed on the upper surface of a case 5, as shown in FIG. 4. When the button 6 is pushed in, a movable contact strip 7 incorporated therein is driven, and a movable contacting point 8 arranged at the tip thereof contacts a fixed contacting point 9 arranged at a position facing thereto. A through hole 10a is formed at two locations on the side surface of a base 10. The through hole 10a is used to screw the switch 1 itself to another member, and is formed in the existing switch 1 from the beginning. Various terminals 10b are projected from the lower surface of the base 10 to be mountable to a printed substrate P.

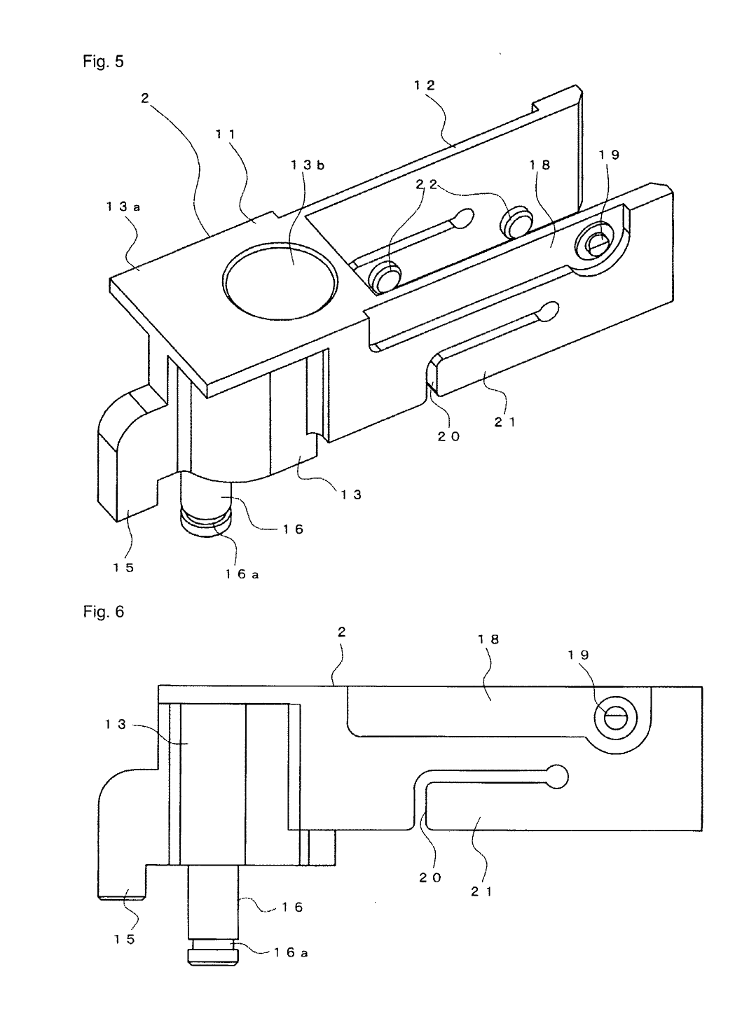

The housing 2 is obtained by molding and processing a synthetic resin material (e.g., polyacetal resin (POM: polyoxymethylene)), and is configured by a housing main body 11, and a pair of flat plates 12 extending therefrom, as shown in FIGS. 5 and 6.

The housing main body 11 includes a middle part 13 having a substantially circular cross section, and a collar part 13a having a substantially rectangular shape in plan view is formed at the upper end of the middle part 13. A concave part 13b having a circular shape in plan view when seen from above is formed in the housing main body 11. The concave part 13b is formed at a position shifted from the axial center of the middle part 13, and a through hole 13c is perforated at the center of the bottom surface. A spring holder 14 can be arranged in the concave part 13b. A stopper part 15 extending laterally and then downward is formed at the external surface of the middle part 13. The lower end of the stopper part 15 projects downward further than the lower surface of the middle part 13. A supporting shaft 16 is arranged at the central part of the lower surface of the middle part 13. An annular groove 16a is formed at the distal end side of the supporting shaft 16, and a fixed ring 17 is attached thereto. The concave part 13b and the through hole 13c are arranged at a position substantially point symmetric with respect to the stopper part 15 with the supporting shaft 16 at the center.

The flat plate 12 is formed with a concave portion 18 along the upper edge on the upper side of the outer surface, and a guide shaft part 19 is formed on the distal end side thereof. The concave portion 18 spreads into a circular shape at the periphery of the guide shaft part 19. At the lower side of each flat plate 12, a slit 20 of a substantially L-shape is formed upward from the lower edge and then towards the distal end side, thereby forming an elastic tongue strip 21. Engagement projections 22 are formed on the inner surface of the distal end side of the elastic tongue strip 21 and on the inner surface near the proximal part. The engagement projection 22 engages with the through hole 10a formed in the base 10 of the switch 1.

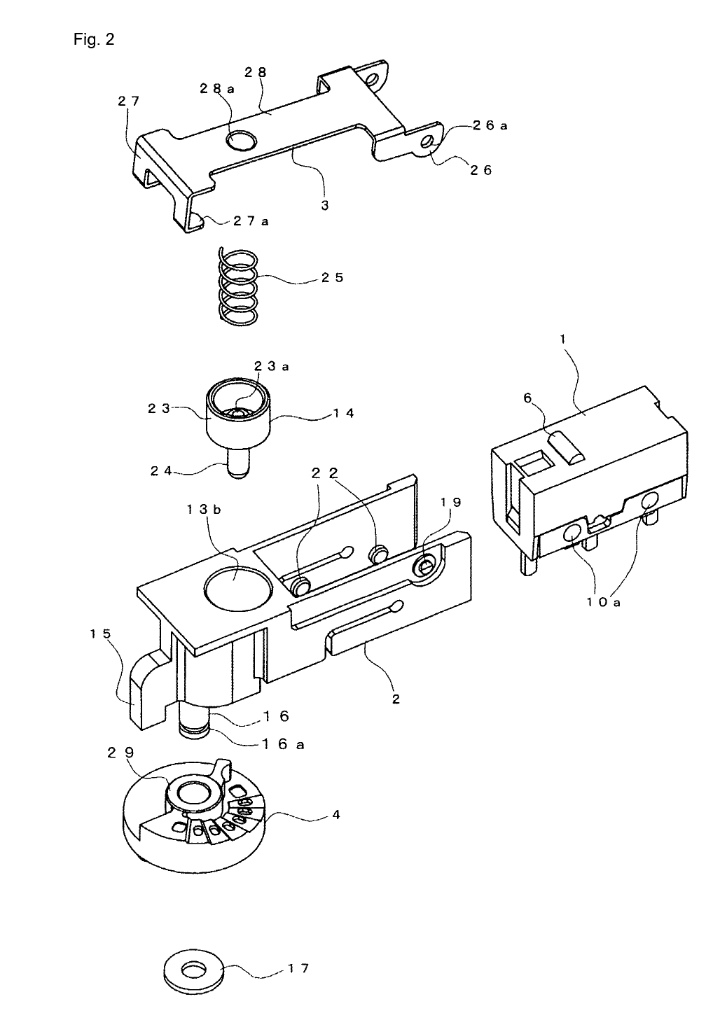

The spring holder 14 is made of a synthetic resin material similar to the housing 2, as shown in FIG. 2, and is configured by a tubular part 23 having the upper surface opened and a projecting part 24 extending downward from the central part of the lower surface of the tubular part 23. A projection 23a is formed at the central part of the bottom surface of the tubular part 23. A coil spring 25 is arranged in the tubular part 23. The projection 23a guides the coil spring 25 at the inner peripheral side of the lower end; however, the inner peripheral surface of the tubular part 23 may guide the coil spring 25 at the outer peripheral side, or the coil spring 25 may be sandwiched by both. In the former case, the projection 23a is not necessarily required. The projection 24 is inserted through the through hole 13c formed in the concave part 13b of the housing main body 11, and projects from the lower surface.

The drive lever 3 is formed by press working a metal plate material such as stainless steel, and has a bearing part 26 formed on one end and an engagement pawl part 27 formed on the other end, as shown in FIG. 2. The bearing part 26 has a circular shape and is formed with a through hole 26a at the center. The guide shaft part 19 formed in the flat plate 12 of the housing 2 is inserted into the through hole 26a so as to be supported in a freely rotating manner. The engagement pawl part 27 extends downward from both sides and the distal end forms an engagement pawl 27a of bent hook shape. The engagement pawl 27a engages with the collar part 13a of the housing main body 11 to limit the turning range of the drive lever 3. An intermediate part 28 connecting the bearing part 26 and the engagement pawl part 27 is formed to have a width narrower than both ends. Thus, the weight is lighter overall, and the bending work of the bearing part 26 and the engagement pawl part 27 at both ends is facilitated. A projection 28a is formed by press working at the distal end side of the intermediate part 28. The upper end of the coil spring 25 is guided by the projection 28a, and the biasing force of the coil spring 25 acts on the lower surface of the intermediate part 28.

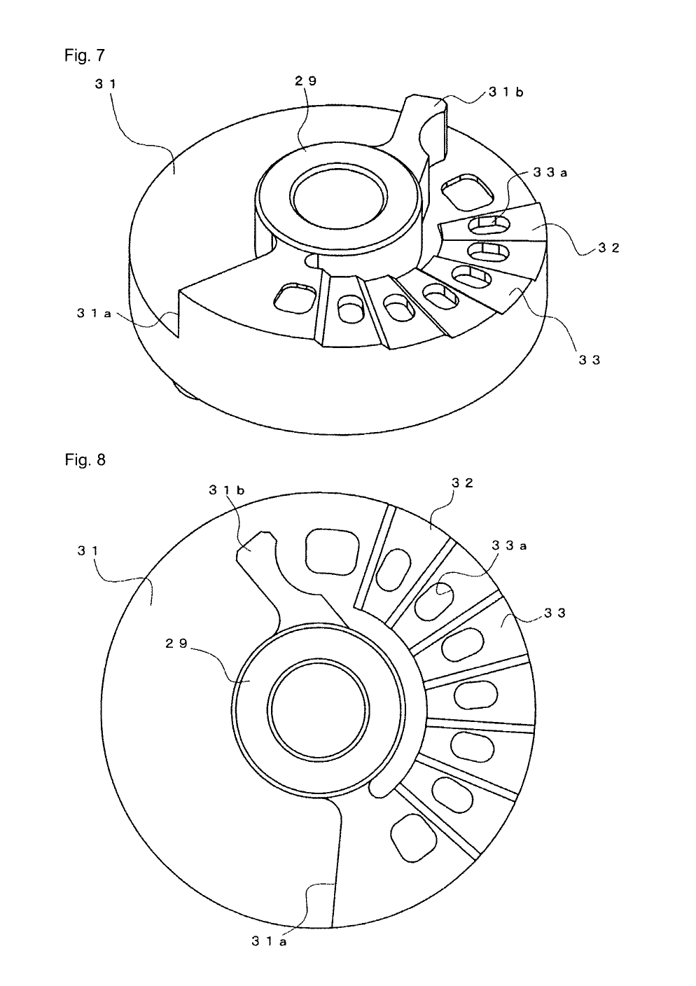

The adjustment dial 4 is made of a synthetic resin material similar to the housing 2, has a disc shape and formed with a tubular part 29 at the center, as shown in FIGS. 7 and 8, which is inserted with the supporting shaft 16 of the housing main body 11. A grip part 30 is formed on the lower surface of the adjustment dial 4 downward towards a position shifted from the center (eccentric position). The adjustment dial 4 can be rotated by way of the grip part 30. The upper surface of the adjustment dial 4 includes a rotation regulating part 31 on the side corresponding to the grip part 30 and a load adjusting part 32 on the opposite side.

At the rotation regulating part 31, the stopper part 15 of the housing main body 11 is positioned, and the rotation regulating part 31 includes two contacting parts 31a, 31b to which the stopper part 15 contacts when the adjustment dial 4 is forward reverse rotated. Each contacting part 31a, 31b is in a positional relationship of a predetermined angle (150° herein) in the circumferential direction. One contacting part 31a is configured by an end face (end face extending in the radial direction) in the circumferential direction of a supporting board 33 at the highest position. The other contacting part 31b is configured by one of the side faces (contacting surfaces) of a projection formed in the radial direction adjacent to the supporting board 33 at the lowest position. A recess is formed in the up-and-down direction at the other side face of the projection.

The load adjusting part 32 is configured by a plurality of supporting boards 33 formed in a staircase pattern in the circumferential direction. An engagement concave part 33a is formed in each supporting board 33, so that the projection 24 of the spring holder 14 is detachably engaged with the engagement concave part 33a. Each engagement concave part 33a is formed in a track shape extending in the radial direction. Here, the height from the lowest position to the highest position of the supporting board 33 is 1.5 mm, and the number thereof is eight. A gap is formed between the load adjusting part 32 and the tubular part 29.

The method of assembling the switch device SW of the above configuration will be described below.

First, the housing 2 is attached to the switch 1. In attaching the housing 2, the engagement projection 22 is engaged with the through hole 10a of the switch 1 while the flat plate parts 12 are elastically deformed to be moved away from each other. In addition to the formation of the concave portion 18 in the flat plate part 12 to alleviate the entire rigidity, the elastic tongue strip 21 is formed by the slit 20, and thus not only the engagement projection 22 on the free end side of the flat plate part 12 but also the engagement projection 22 on the free end side of the elastic tongue strip 21 are smoothly engaged with the through holes 10a of the switch 1.

Next, the spring holder 14 is arranged in the concave part of the housing 2, and the coil spring 25 is arranged in the tubular part 23 of the spring holder 14. The coil spring 25 has the outer peripheral side thereof guided by the inner peripheral surface of the tubular part 23. The drive lever 3 is attached to the housing 2. The drive lever 3 is turnably attached to the housing 2 by engaging the guide shaft part 19 formed in the concave portion 18 of the housing 2 with the through hole 26a while elastically deforming the bearing parts 26 in the direction of moving away. The engagement pawl part 27 of the drive lever 3 is then engaged with the collar part of the housing 2. Thus, the drive lever 3 can be turned at an angle within a predetermined range with respect to the housing 2. Since the engagement pawl part 27 is formed in the drive lever 3, the dimension in the height direction at the relevant portion is suppressed in comparison with the case of adopting the configuration of engaging the free end of the drive lever 3 to the housing 2.

Furthermore, the adjustment dial 4 is attached to the lower surface of the housing main body 11. The adjustment dial 4 is attached by inserting the supporting shaft 16 of the housing main body 11 to the tubular part 29, and engaging the fixed ring 17 with the annular groove 16a formed at the distal end of the supporting shaft 16. The stopper part 15 is positioned in the rotation regulating part 31 at this point. The projection 24 of the spring holder 14 is engaged with the engagement concave part 33a of one of the supporting boards 33 of the load adjusting part 32. The coil spring 25 held at the spring holder 14 is pressure contacted to the lower surface of the distal end side of the drive lever 3, whereby the drive lever 3 is turned to the position (initial position) that is spaced apart from the button 6 of the switch 1.

In the switch device SW assembled in this manner, the biasing force of the coil spring 25 acting on the operation lever can be adjusted by rotating the adjustment dial 4 by way of the grip part 30. That is, when the adjustment dial 4 is rotated, the projection 24 of the spring holder 14 engaged in a pressure contacting state with the engagement concave part 33a of a certain supporting board 33 sequentially changes the engagement position to the engagement concave part 33a of the adjacent supporting board 33. The spacing between the spring holder 14 and the drive lever 3 changes, since the supporting board 33 is formed in a staircase pattern. That is, the initial length of the coil spring 25 is changed, and the biasing force on the drive lever 3 is adjusted. The projection 24 of the spring holder 14 pressure contacts the engagement concave part 33a of the adjustment dial 4, and the stopper part 15 of the housing 2 contacts the adjustment dial 4 at a position substantially point symmetric with the center of rotation at the center. Therefore, balance is maintained, and the adjustment dial 4 is smoothly rotated.

The above assembly method is merely an example, and the housing 2 may be attached to the switch 1 after the spring holder 14, the coil spring 25, and the adjustment dial 4 are attached to the housing 2.

The operation of the switch device SW having the above configuration will now be described.

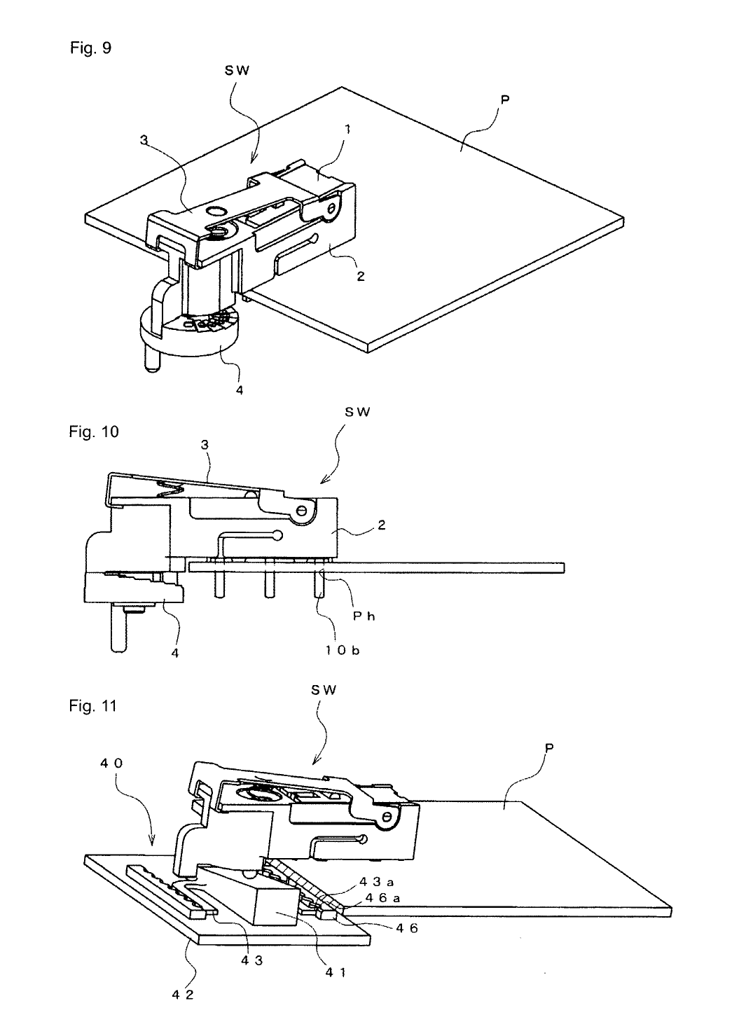

The switch device SW is mounted on a printed substrate P, as shown in FIGS. 9 and 10, and for example, is incorporated in a mouse of a computer (not shown) and used for detecting click on the mouse. In mounting the switch device SW to the printed substrate P, the terminals projecting from the base 10 of the switch 1 are respectively inserted to terminal holes Ph formed in the printed substrate P that is mounted with various electronic components, and fixed through soldering.

A user checks the repulsive force due to the biasing force of the coil spring 25 by clicking the mouse, and rotates the adjustment dial 4 by way of the grip part 30 so as to obtain an appropriate click feeling that meets his/her preference. The biasing force of the coil spring 25 is adjustable at multi-levels by the plurality of supporting boards 33 formed on the adjustment dial 4. Therefore, the biasing force can be adjusted so as to reliably obtain a particular click feeling desired by the user.

### Second Embodiment

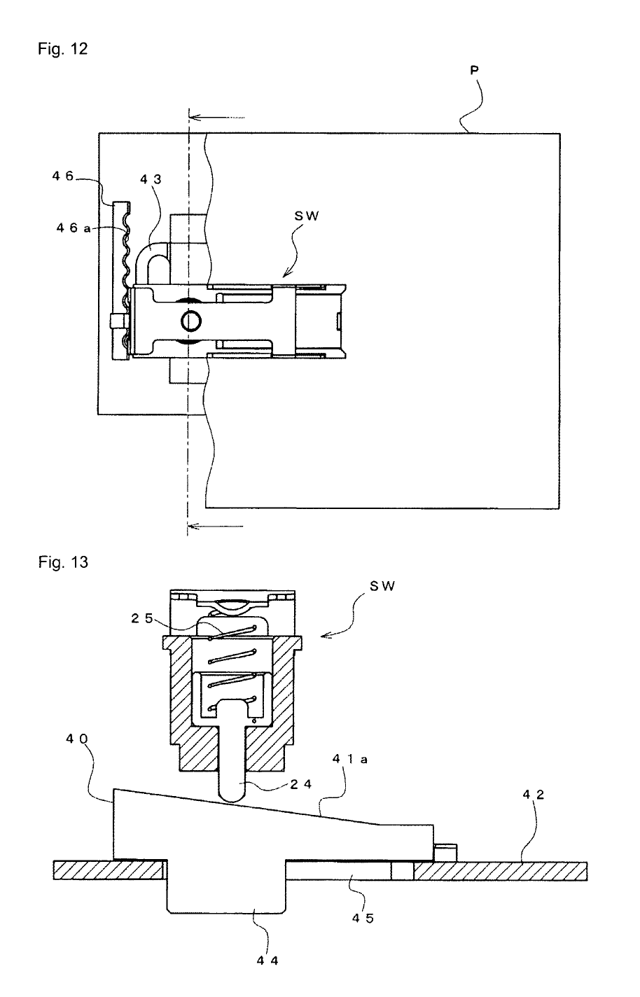

FIGS. 11 to 13 show a switch device SW according to a second embodiment. The components of the switch device SW are substantially the same as those in the first embodiment, but differ in that a slider 40 is used in place of the adjustment dial 4.

That is, the slider 40 is arranged on the printed substrate P to which the switch 1 is mounted, and is configured by a slider main body 41 and a slider supporting member 42.

The slider main body 41 has an inclined surface 41a which gradually goes upwards towards one end side, on the upper surface, and a substantially L-shaped elastic engagement strip 43 is formed on both sides of the slider main body 41. Each elastic engagement strip 43 is elastically deformable to move closer to or away from the side surface of the slider main body 41 and is formed with an engagement projection 43a at the distal end portion. A guide part 44 extending in the longitudinal direction is formed at the center part of the bottom surface of the slider main body 41.

The slider supporting member 42 has a flat plate shape to be attached to the bottom surface side of the printed substrate P. A guide hole 45 for guiding in a reciprocating manner the guide part 44 of the slider main body 41 is formed at the center part of the slider supporting member 42. An engagement receiving part 46 in which a plurality of engagement concave parts 46a, with which the engagement projection 22 of the elastic engagement strip 43 engages and disengages, is formed continuously in a wave form is formed at predetermined intervals on both sides in the upper surface of the slider supporting member 42.

The slider 40 of the above configuration is fixed at the bottom surface of the printed substrate P through screwing etc. after mounting the slider main body 41 on the slider supporting member 42, and engaging the engagement projection 43a with the engagement concave part 46a while elastically deforming the elastic engagement strip 43 on both sides inwards. In this state, the inclined surface 41a of the slider main body 41 projects upwards through an opening (not shown) formed in the printed substrate P, so that the projection 24 of the spring holder 14 is pressure contacted thereto. Therefore, when the slider main body 41 is slid with respect to the slider supporting member 42, the engagement position of the engagement projection 43a with respect to the engagement concave part 46a changes and the position of the inclined surface 41a to which the projection 24 contacts also changes. The spacing to the contacting position with the drive lever 3, in which the coil spring 25 is interposed, thus can be changed. Consequently, the biasing force of the coil spring 25 is changed and the force required for the operation of the drive lever 3 is adjusted.

### Third Embodiment

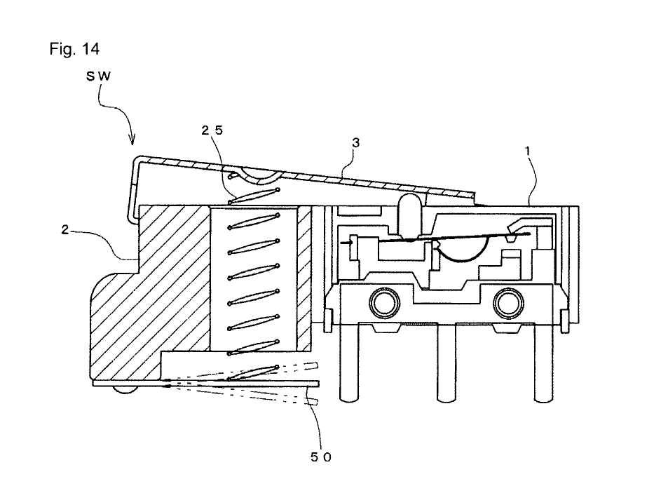

FIG. 14 shows a switch device SW according to a third embodiment. In the switch device SW, a supporting plate 50 arranged at the bottom surface of the housing 2 is used in place of the adjustment dial 4 and the slider 40.

The supporting plate 50 is made of a plate spring and has one end side fixed to the bottom surface of the housing 2 with a screw etc., and has the upper surface on the other end side pressure contacted by one end of the coil spring 25. The free end side of the supporting plate 50 may be deformed by bending etc., as shown with a chain double-dashed line in the figure as necessary, or supported by other members (not shown) to adjust the biasing force of the coil spring 25.

1. A switch device comprising:
a switch including a push-in operable operation part;
a housing attached to the switch;
a push-in unit turnably attached to the housing to push in the operation part;
a biasing unit, arranged in the housing, for biasing the push-in unit to position the operation part at a non-push-in position before being pushed in; and
a biasing force adjusting unit for adjusting the biasing force applied on the push-in unit by the biasing unit at multi-levels or no level.

2. A switch device according to claim 1, wherein the biasing force adjusting unit has a configuration in which a distance to the push-in unit in which the biasing unit is arranged is adjustable.

3. A switch device according to claim 1, further comprising:
a holding unit arranged in a reciprocating manner in the housing, wherein the biasing unit is held between the holding unit and the push-in unit, and the biasing force adjusting unit contacts the holding unit to adjust the position in the reciprocating direction.

4. A switch device according to claim 3, wherein:
the biasing unit includes a coil spring;
the holding unit includes a spring holder of a bottomed tubular shape in which one end side of the coil spring is arranged, the spring holder including a projection passing through the housing and projecting to the side opposite from the push-in unit; and
the biasing force adjusting unit is rotatably attached to the housing on the side opposite from the push-in unit, is contacted by the projection passed through the housing and projected, and includes a contacting part for displacing the position in the reciprocating direction with respect to the projection by being rotated.

5. A switch device according to claim 4, wherein the contacting part of the spring holder is configured by a plurality of supporting boards continuous in a staircase pattern in the rotating direction.

6. A switch device according to claim 5, wherein each supporting board includes an engagement concave part with which the projection of the spring holder is detachably engaged.

7. A switch device according to claim 3,
wherein the switch is mounted on a substrate, and
the biasing force adjusting unit is slidably arranged on the substrate, and is configured by a slide member for displacing the reciprocating position of the holding unit by the slide position.

8. A switch device according to claim 2, further comprising:
a holding unit arranged in a reciprocating manner in the housing,
wherein the biasing unit is held between the holding unit and the push-in unit, and
the biasing force adjusting unit contacts the holding unit to adjust the position in the reciprocating direction.

9. A switch device according to claim 8, wherein:
the biasing unit includes a coil spring;
the holding unit includes a spring holder of a bottomed tubular shape in which one end side of the coil spring is arranged, the spring holder including a projection passing through the housing and projecting to the side opposite from the push-in unit; and
the biasing force adjusting unit is rotatably attached to the housing on the side opposite from the push-in unit, is contacted by the projection passed through the housing and projected, and includes a contacting part for displacing the position in the reciprocating direction with respect to the projection by being rotated.

10. A switch device according to claim 9, wherein the contacting part of the spring holder is configured by a plurality of supporting boards continuous in a staircase pattern in the rotating direction.

11. A switch device according to claim 10, wherein each supporting board includes an engagement concave part with which the projection of the spring holder is detachably engaged.

12. A switch device according to claim 8,
wherein the switch is mounted on a substrate, and
the biasing force adjusting unit is slidably arranged on the substrate, and is configured by a slide member for displacing the reciprocating position of the holding unit by the slide position.
